(19) United States
(12) Patent Application Publication
(10) Pub. No.: US 2025/0135553 A1
(43) Pub. Date: May 1, 2025

(54) SYSTEMS AND METHODS FOR ELECTRICAL RESISTANCE DIAGNOSTIC FOR CONDUCTIVITY MONITORING IN LASER POWDER BED FUSION

(71) Applicant: Lawrence Livermore National Security, LLC, Livermore, CA (US)

(72) Inventors: Saptarshi MUKHERJEE, Newark, CA (US); Nicholas P. CALTA, San Jose, CA (US); Michael Frederick CRUMB, Diablo Grande, CA (US); Edward BENAVIDEZ, Moraga, CA (US); Gabriel Mark GUSS, Manteca, CA (US)

(21) Appl. No.: 18/498,632

(22) Filed: Oct. 31, 2023

(51) Int. Cl. B22F 12/30; B22F 10/85; B22F 12/41; B33Y 10/00; B33Y 30/00; B33Y 50/02

(52) U.S. Cl. CPC B22F 12/30; B22F 10/85; B22F 12/41; B33Y 10/00; B33Y 30/00; B33Y 50/02

(57) ABSTRACT

The present disclosure relates to an additive manufacturing system for building a part from a feedstock material on a build table. The system may make use of a plurality of electrodes in contact with the build table, and a current source configured to provide an electrical current, via a first subplurality of the plurality of electrodes, to the build table. A second subplurality of the plurality of electrodes is configured in contact with a surface of the build table. A voltage measuring subsystem is operably associated with the second subplurality of the plurality of electrodes and configured to measure a potential different between two points on the build table at least one of while, or after, a sintering operation is performed on the feedstock material.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to additive manufacturing systems and methods, and more particularly to an additive manufacturing system and method having a capability to monitor electrical characteristics of tracks of metallic feedstock material being printed, in real time, for the purpose of detecting possible and/or definite defects in a printed track of feedstock material.

### BACKGROUND

The statements in this section merely provide background information related to the present disclosure and may not constitute prior art.

Several x-ray synchrotron diagnostics for high-speed imaging of the LPBF process have been developed in the past several years to better understand the sub-surface material behavior and dynamics during laser-induced melting. Such sub-surface material behavior may involve, for example and without limitation, quantifying pore formation mechanisms, spatter ejection mechanisms, melt pool and vapor depression morphologies, liquid flow in the melt-pool, and other physical phenomena during the LPBF process. These efforts typically require costly, time-consuming and high-volume projection data to provide high-fidelity information about the process. Thus, there is an outstanding need to connect observations made with synchrotron experiments to cheap, scalable process monitoring diagnostics that do not rely on synchrotron infrastructure to draw conclusions about the behavior of the LPBF process.

Full topical reviews on in-situ diagnostics for LPBF are publicly available in present day technical literature. Out of these topical reviews, a few complementary diagnostics involve pyrometric readings to monitor laser melting, optical tomography for defect detection, acoustics emission measurements for identifying porosities, laser-based ultrasound to detect surface and sub-surface defects in laser melt lines, thermionic emission for resolving laser-metal dynamics as well as sensor data fusion approaches to reliably predict the onset of pore formation. However, these techniques lack sensitivity towards electromagnetic discontinuities such as electrical conductivity variations from lack of fusion or temperature fluctuations.

The ability to monitor electrical conductivity variations in a metal material is highly valuable as it enables one to obtain crucial information about the structure or part, such as mechanical discontinuities and defects. For such a need, a current injection-based method, such as electrical resistance measurements, can be used to detect discontinuities in resistances in metals. The electrical resistance technique initially gained popularity in geophysics in the 1920s to obtain maps of the Earth's sub-surface conductivity. The technique has since been widely developed in a broad range of applications, including biomedical imaging applications, detecting damage or strain states in construction materials.

When considering developing and implementing a real time, electrical resistance experimental diagnostic as a nondestructive evaluation (NDE) method for analyzing prints in an LPBF technique, however, several significant challenges exist in adapting this technology towards AM metal part inspection. While electrical resistance tomography (ERT) approaches exist that reconstruct the conductivity distribution of a conductive target based on boundary electric voltage measurements, these approaches rely on numerous electrode pairs and multiple current injection patterns followed by computationally intensive tomographic reconstruction algorithms to reconstruct conductivity values. This limits the technique's ability to be minimally invasive and perform real time detection during a time-sensitive printing process.

Accordingly, an important need still exists in real time monitoring techniques that are easily integrated into LPBF applications for detecting electromagnetic discontinuities resulting from a lack of proper fusion or temperature fluctuations of feedstock material which is being selective fused together on a build plate.

### SUMMARY

This section provides a general summary of the disclosure, and is not a comprehensive disclosure of its full scope or all of its features.

In one aspect the present disclosure relates to an additive manufacturing system for building a part from a feedstock material on a build table. The system may comprise a plurality of electrodes in contact with the build table, and a current source configured to provide an electrical current, via a first subplurality of the plurality of electrodes, to the build table. A second subplurality of the plurality of electrodes is configured in contact with a surface of the build table. A voltage measuring subsystem operably associated with the second subplurality of the plurality of electrodes and configured to measure a potential different between two points on the build table, at least one of while, or after, a sintering operation is performed on the feedstock material.

In another aspect the present disclosure relates to an additive manufacturing system for building a part from a feedstock material on an electrically conductive build table. The system may comprise an electronic controller, the build table, a first plurality of current injection electrodes in contact with the build table, and a current source. The current source may be configured to generate an electrical current and to circulate the electrical current via the first plurality of current injection electrodes through the build table. A voltage measuring subsystem may be included which is in communication with the electronic controller and operably associated with a second subplurality of the plurality of electrodes. The voltage measuring subsystem may be configured to measure a potential difference between two points on the build table, at least one while, or after, the feedstock material is being sintered. The first subplurality of electrodes may be angular disposed 180 degrees from one another on the build table.

In still another aspect the present disclosure relates to an additive manufacturing method for building a part from a feedstock material on an electrically conductive build table. The method may comprise circulating a current through the build table. The method may further include measuring a voltage across two spaced apart points on the build table while the current is being circulated through the build table to obtain a voltage measurement, at least one of while, or after, the feedstock material is being sintered. The method may further include using the voltage measurement to determine a characteristic indicative of a quality of the sintering of the feedstock material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level block diagram of one embodiment of a system in accordance with the present disclosure;

FIG. 1a is a plan diagram of the build table illustrating in greater detail one example for a placement of the current injection electrodes a placement of the voltage measurement electrodes on a common circumferential track;

FIG. 2 is a graph illustrating measured versus simulated voltage measurements for different numbers of printed traces on the discs shown in FIG. 3;

FIGS. 3a-3e show discs with 0-10 traces printed thereon, from which the measurements for the graph of FIG. 2 were obtained; and

FIG. 4 shows one example of a flowchart illustrating various operations that may be performed in accordance with a method of the present disclosure.

### DETAILED DESCRIPTION

Example embodiments will now be described more fully with reference to the accompanying drawings.

The present disclosure overcomes the above-described drawbacks and limitations of previous systems that have used electrical resistance tomography through systems and methods which employ a new, minimally invasive monitoring approach. In some embodiments the systems and methods of the present disclosure employ a minimally-invasive, four electrode approach: two for current injection and two for voltage measurement. This four electrode approach enables studying the effect of single and multiple LPBF-tracks and prints on the diagnostic measurements. Additionally, the surface area of the current injection electrodes needs to be sufficiently large to allow high current density, while the small surface area of the voltage measurement electrodes needs to be sufficiently small enough to avoid ‘averaging’ several equipotentials. In some embodiments this is accomplished by utilizing electrodes with tapered tips that provide high current, in some embodiments up to or even exceeding five amps, over a uniform area. The use of electrodes with tapered tips also provides the capability to measure small voltage fluctuations, for example fluctuations of only 0.1 mV or even less.

Finally, prior literature on resistance measurements have relied on invasive techniques such as directly soldering electrodes onto the part or additional connection support built on to the part to reduce contact impedance mismatch and provide efficient electrical contact. The present disclosure overcomes such invasive configurations and provides a minimally invasive solution which in some embodiments involves the use of magnetic arms that help maintain a strong electrical connection along with a high degree of mechanical flexibility.

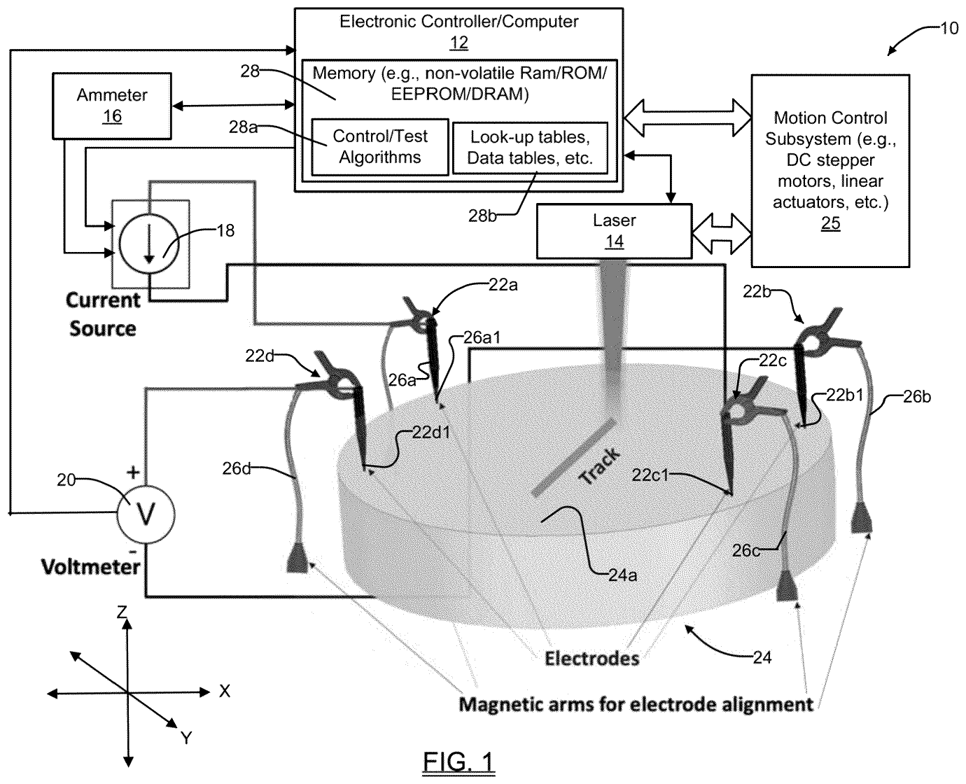

Referring to FIG. 1, one embodiment of a system 10 in accordance with the present disclosure is shown. In this example the system 10 may include a controller 12, a laser 14, an ammeter 16, a DC current source 18, a voltage measuring subsystem, in this example a voltmeter 20, a plurality of narrow tip electrodes 22a-22d (which may also understood as “probes”) for making electrical contact with an electrically conductive build table 24, and a corresponding plurality of flexible magnetic arms 26a-26d for enabling precise alignment of tip portions 22a1-22d1 of the electrodes with specific areas or regions of an upper surface 24a of the build table. In some embodiments the DC current source 18 could instead be an AC current source, for example to better enable changes in capacitance or inductance, instead of resistant.

In some embodiments the system 10 may also include a motion control subsystem 25. The motion control subsystem 25 may be included for controlling movement of the laser 14 in X, Y and/or Z planes as needed. Optionally, the motion control subsystem 25 may be used to control movement of the build table 24 in at least one of X, Y or Z planes. In some embodiments the motion control subsystem 25 may be configured to control movement of both the laser 14 and the build table 24, however, it is anticipated that in most instances it will be preferred to move the laser 14 as needed during a printing process while the build table 24 is held stationary.

In some embodiments the motion control subsystem 25 may be responsive to scanning control signals supplied by the controller 12. In some embodiments the motion control subsystem 25 may include its own controller (not shown) which may or may not communicate with the controller 12.

In some embodiments the current source 18 is connected to a pair of the electrodes, in this example electrodes 22a and 22c, which are positioned at points 180 degrees from one another on the build table 24. Current will then flow through the entire volume of the build table 24. In some embodiments the voltmeter 20 is connected to the other two of the electrodes, in this example electrodes 22b and 22d. The magnetic arms 26a-26d are secured to a metal structure or table (not shown) which allows the magnetic arms 26a-26d to be used to position and hold the tips 22a1-22d1 of the electrodes 22a-22d at highly precise locations on the build table 24.

The electronic controller 12 may include a memory 28, for example and without limitation, a non-volatile memory (e.g., RAM/ROM/DRAM/EEPROM, etc.), for storing a software module 28a including control and/or test algorithms, as well as a module 28b for storing look-up tables, data tables, performance curves, historical data such as measurements, etc.

Referring to FIG. 1a, a plan view of the build table 24 is shown to help illustrate one example of placement of the current injection electrodes 22a and 22c, and one possible placement of the voltage measurement electrodes 22b and 22d. In some embodiments it is preferred that the current injection electrodes 22a and 22c are diametrically opposite one another on the build table 24 (i.e., spaced 180 degrees from one another). This ensures that current will flow generally evenly over the full area of the build table 24, within its volume and near the upper surface 25a. Furthermore, in some embodiments the current injection probes 22a and 22c are preferably disposed equidistantly inwardly from an outer perimeter edge of the build table 24, such as on circumferential track 24b shown in FIG. 1a. The distance of the track 24b from the outermost edge of the build table 24 may vary depending on many factors, for example on the overall diameter of the build table 24, the precise shape of the part being formed on the build table 24, and other factors, possibly considerations involving preventing or limiting the electric currents injected into the build table from interacting with the laser source when performing an LPBF printing operations. In some embodiments the track 24b may be spaced between about 20 mm-30 mm inwardly from the outer perimeter edge of the build table 24, but again the optimal spacing will be dictated on a plurality of factors including, of particular importance, the overall dimension of the build table and the.

The voltage measurement electrodes 22b and 22d, in some embodiments, are angularly spaced equidistantly from the current injection electrodes 22a and 22c. In some embodiments the voltage measurement electrodes 22b and 22d are also located on the track 24b, and in some embodiments they are located inwardly of the track 24b closer to the axial center of the build table, and in some embodiments they are located slightly radially outwardly of the track 24b. In some embodiments the voltage measurement electrodes 22b and 22d may also be radially offset from the track 24b (e.g., electrode 22b may be radially inwardly of the track 24b while electrode 22d is positioned radially outwardly of the track 24b). It is anticipated that in most embodiments, simplicity and/or accuracy of voltage measurements obtained will be optimally served by locating the voltage measurement electrodes 22b and 22d on the same track 24b as the current injection electrodes 22a and 22c.

With further reference to FIG. 1a, it should be appreciated that a plurality of pairs of current injection electrodes 22a/22c may be positioned angularly around the build table, and optionally along with a plurality of voltage measurement electrodes 22b/22d positioned angularly around the build table 24. The current injection electrodes 22a/22d and voltage measurement electrodes 22b/22d may all be located on the same radial track (e.g., track 24a) or on different tracks. One pair at a time of current injection electrodes 22a/22c and voltage measurement electrodes 22b/22d may then be used at a time, in a multiplexed fashion, to obtain voltage measurements. The ability to inject multiple current injection patterns lead to more interaction with the printed tracks or parts, which could be used for better conductivity reconstruction, in comparison to using a single pair of current injection and voltage measurement. This technique also allows a voltage measurement “map” of the entire surface area of the build table 24 to be created and, in some instances, may lead to even further accuracy or sensitivity in the voltage measurements obtained during a printing operation.

The angular offset positioning of the voltage measurement electrodes 22b and 22d relative to the current injection electrodes 22a and 22c also affects the accuracy and sensitivity of the voltage measurements obtained. Placing the voltage measurement electrodes 22b and 22d too close to the current injection electrodes 22a and 22c may negatively influence the voltage measurements obtained because of the excessive influence of the current being injected. Conversely, placing the voltage measurement electrodes 22b and 22d too far (angularly speaking) from the current injection electrodes 22a and 22c can result in voltage measurements that are unduly negatively affected by noise. In some embodiments it is preferred that the voltage measurement electrodes 22b and 22d are angularly offset by between about 10-60 degrees, and in some embodiments by between about 20-50 degrees, and in some embodiments more preferably by between about 30-45 degrees. The precise angular offset selected will likely depend on various factors including the magnitude of current being injected, the shape of the part being made, the feedstock material being used to form the part, and likely other factors as well.

In some embodiments a Keithley 2230G-30-1 DC power supply was used as the differential current source 18. In some embodiments the current supplied by the current source 18 was about 5 amps. In some embodiments an Agilent 34411A 6½ digit digital multimeter was used as the voltmeter 20 for obtaining the voltage measurements. Voltage measurements may be obtained in accordance with virtually any selected time interval, but in some embodiments voltage measurements obtained about one every 1 ms-10 ms is likely to be sufficient to monitor the quality of the trace being printed with the laser 14.

The four magnetic-based arms 26a-26d may be flexible metal arms 26a-26d, which are commercially available from various sources, one of which is Kotto, Inc. of Santa Clara, CA. The magnetic-based arms 26a-26d are used to connect the electrodes 22a-22d to the build plate 24 with strong mechanical pressure that help maintain a strong, reliable electrical connection, and thus help lead to lower contact impedance losses. The flexible magnetic 26a-26d arms may be placed in a steel weighted base that provide a high degree of mechanical flexibility to conform to small geometries and can be easily translated (i.e., hand carried) to a complex manufacturing system with limited space for connection.

In some embodiments the tips 22a1-22d1 of the electrodes 22a-22d are tapered copper tips that provide a strong electrical connection to the build table 24, and which enable a high current flow (e.g., 5 amps) over a uniform area (e.g., over all or substantially all of the build table 24). In some embodiments the tips 22a1-22d1 are high precision tapered copper tips (i.e., IGREAT ET Tip Series) and are plated with iron, nickel and chromium, typically used for soldering purposes, but which are readily used as part of the system 10. These features make the 4-point probe/electrode system minimally non-invasive, with optimized electrode current injection, and also provide the capability to measure small voltage fluctuations (down to 0.1 uV or even smaller), without complex circuitry. The above-described components and features importantly enable the entire build table 24 with the electrodes 22a-22d, flexible arms 26a-26d and associated support table (not shown) to be easily translated within a given work area for in-situ integration into an AM printing system.

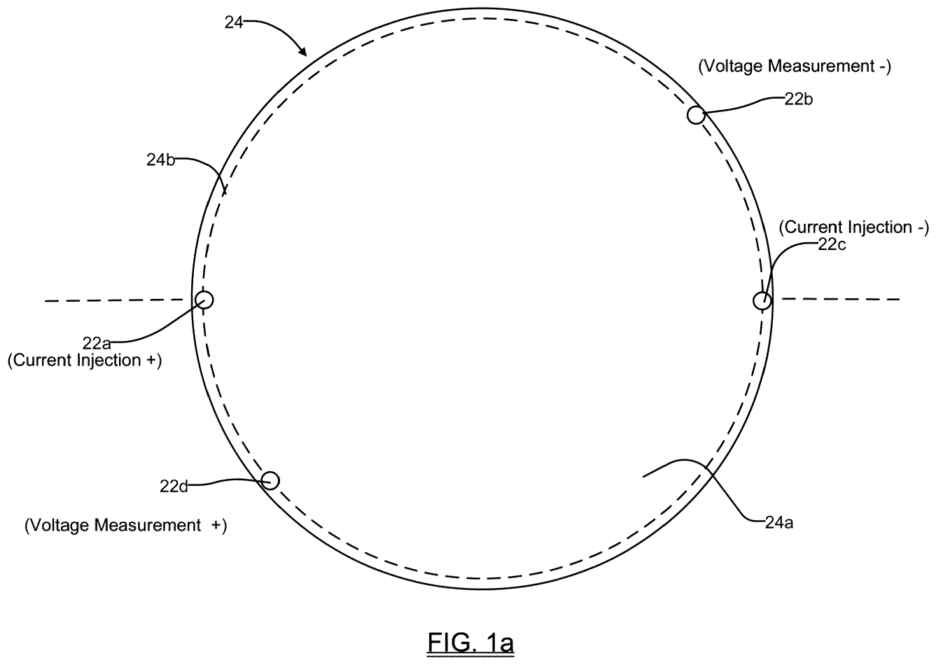

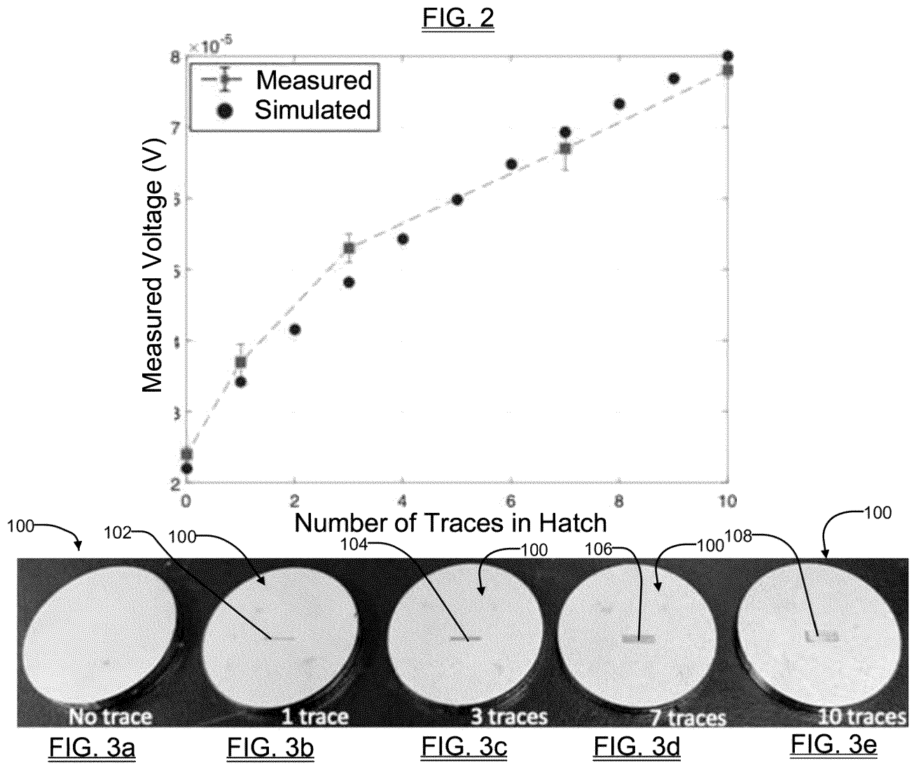

Referring FIGS. 2 and 3a-3e, the sensitivity (FIG. 2) of the resistance diagnostic towards single layer hatches (FIGS. 3a-3e) printed by a laser-based system are shown. Five different coupons 100, which in this example are stainless steel discs of diameter 1 inch, as shown in FIGS. 3a-3e, were used as the base material. A laser was used to create four single layer hatches 102, 104, 106 and 108, each having a length of 4 mm, and with the number of traces increased from 1 (FIG. 3b) to 10 (FIG. 3e) (i.e., 1, 3, 7 and 10, respectively, as shown in FIGS. 3b-3e). The print parameters used to create these hatches were as follows; laser power of 300 W, scan speed of 500 mm/s, laser beam diameter of 100 μm, hatch spacing of 100 μm and a scan length of 4 mm. Microscopic images of the 4 hatch samples showed that in these examples the width of the hatch varies from 200 μm for the 1 trace-sample (FIG. 3b) to 0.2 mm for the 10 trace-sample (FIG. 3e).

Opposite current injection with opposite diagonal measurement configuration (such as shown in FIG. 1) was used as the current injection pattern and measurement mode for these measurements. The key finding of the measurements is that the effect of a single trace hatch (FIG. 3b) was detected with a measurable voltage of 15 uV with respect to a disc with no hatch printed. An increase in the width of the hatch increases the hatch cross sectional area, leading to a higher overall resistance across the hatch, resulting in a higher computed (e.g., measured/detected) voltage. Thus, the measured voltage increases with increasing resistance due to increasing traces which form the hatch, with the 10-trace hatch (FIG. 3e) providing an 80 μV voltage. Stable measurements are able to be made with a maximum variation of about 2.5 uV. These results demonstrate that a single trace hatch can be easily detected and enables the detection of defects within even just a single trace, and very importantly the ability to conduct in-situ conductive monitoring in real time while an LPBF process is being carried out. Thus, the systems and methods of the present disclosure enable corrective actions to potentially be taken during a LPBF printing process, in real time, if needed.

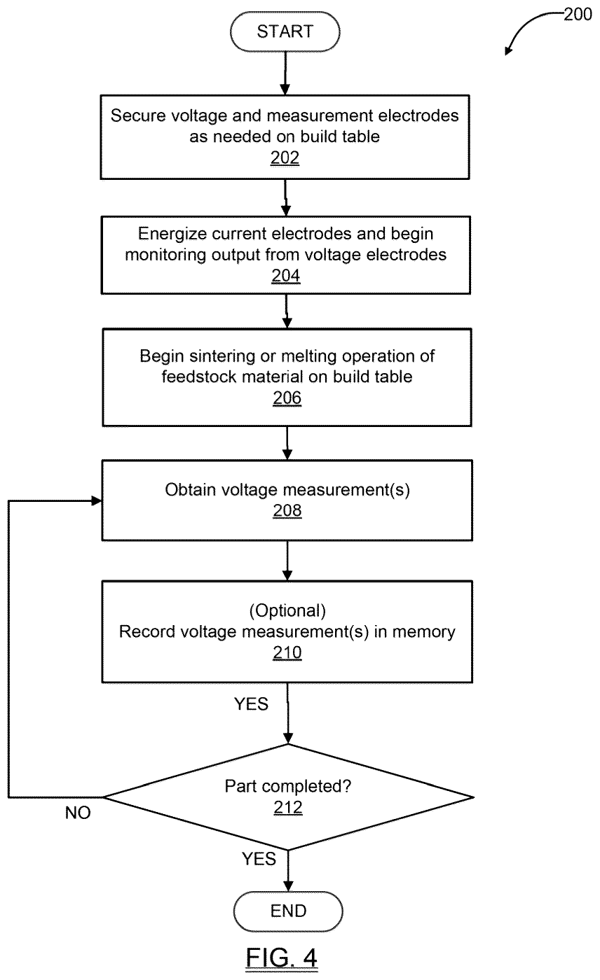

Referring briefly to FIG. 4, a flowchart 200 illustrating one example of operations that may be carried out by a method in operating in accordance with the system 10 is shown. In this example the electrodes 22a-22d are all secured with the respective tips 22a1-22d1 in contact with the upper surface 24a of the build table 24 and at precisely selected angular locations near the perimeter of the build table, as indicated at operation 202. At operation 204 the current electrodes 22a and 22c are energized to cause a current to begin flowing through the build table 24. Also at operation 204, voltage readings are obtained from the electrodes 22b and 22d. At operation 206 the laser 14 begins sintering the feedstock material on the build table 24. At operation 208 the system 10 continues obtaining voltage measurements (either continuously or at short, predetermined time intervals). At operation 210 the just-obtained voltage measurements may be saved in the memory 28 of the system 10. At operation 212 a check is made by the controller 12 if the part being formed is complete, and if not, then operations 208 and 210 (operation 210 being optional) may be repeated. When the check at operation 212 indicates the part is complete, the method concludes. If at any time during operations 208-212 the system 10 obtains a voltage measurement (or short series of voltage measurements) that indicates a discontinuity in the trace being sintered, suitable action may be taken.

The present disclosure demonstrates the successful carrying out of electrical resistance (DC) experiments on LPBF-printed hatch geometries still attached to a build plate. This work successfully demonstrates the sensitivity of the electrical resistance diagnostic towards conductivity variations from LPBF tracks and enables real-time, in-situ deployment of an electrical measurement system for conductivity monitoring at and below the build layer during the manufacturing process.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. An additive manufacturing system for building a part from a feedstock material on a build table, the system comprising:
a plurality of electrodes in contact with the build table;
a current source configured to provide an electrical current, via a first subplurality of the plurality of electrodes, to the build table;
a second subplurality of the plurality of electrodes configured in contact with a surface of the build table; and
a voltage measuring subsystem operably associated with the second subplurality of the plurality of electrodes and configured to measure a potential different between two points on the build table, at least one of while, or after, a sintering operation is performed on the feedstock material.

2. The system of claim 1, further comprising a laser for sintering the feedstock material.

3. The system of claim 1, further comprising a plurality of magnetic arms for supporting the electrodes and enabling adjustable positioning of the electrodes relative to an upper surface of the build table.

4. The system of claim 1, further comprising an ammeter for measuring a current supplied by the current source to the build table.

5. The system of claim 1, wherein the first subplurality of the electrodes comprises two of the electrodes, and where the two electrodes are in contact with an upper surface of the build table at two locations on the build table 180 degrees offset from one another.

6. The system of claim 1, wherein the second subplurality of the electrodes comprises a pair of the electrodes, and where the pair of electrodes are arranged in contact with an upper surface of the build table at locations on the build table 180 degrees offset from one another.

7. The system of claim 1, wherein the second subplurality of the electrodes is offset from the first subplurality of electrodes by between about 10-60 degrees.

8. The system of claim 1, wherein the second subplurality of the electrodes is offset from the first subplurality of electrodes by between about 20-50 degrees.

9. The system of claim 1, wherein the second subplurality of the electrodes is offset from the first subplurality of electrodes by between 30-45 degrees.

10. The system of claim 1, where all of the plurality of electrodes are arranged on a common circumferential track on the build table.

11. The system of claim 1, further comprising an electronic controller in communication with the voltage measuring subsystem for receiving voltage measurements obtained by the voltage measuring subsystem.

12. The system of claim 1, further comprising a motion control subsystem operably associated with the laser for moving the laser along or within at least one of X, Y and Z planes.

13. The system of claim 1, further comprising the build table, and wherein the build table is round.

14. An additive manufacturing system for building a part from a feedstock material on an electrically conductive build table, the system comprising:
an electronic controller;
the build table;
a first plurality of current injection electrodes in contact with the build table;
a current source configured to generate an electrical current and to circulate the electrical current via the first plurality of current injection electrodes through the build table;
a voltage measuring subsystem in communication with the electronic controller and operably associated with a second subplurality of the plurality of electrodes and configured to measure a potential different between two points on the build table, at least one while, or after, the feedstock material is being sintered; and
wherein the first subplurality of electrodes are angular disposed 180 degrees from one another on the build table.

15. The system of claim 14, further comprising a plurality of flexible magnetic arms for supporting the plurality of electrodes.

16. The system of claim 14, further comprising a laser for sintering the feedstock material.

17. The system of claim 16, further comprising a motion control subsystem for moving at least one of the laser or the build table in at least one of X, Y or Z planes.

18. The system of claim 14, further comprising an ammeter for monitoring a magnitude of the current generated by the current source.

19. An additive manufacturing method for building a part from a feedstock material on an electrically conductive build table, the method comprising:
circulating a current through the build table;
measuring a voltage across two spaced apart points on the build table while the current is being circulated through the build table to obtain a voltage measurement, at least one of while, or after, the feedstock material is being sintered; and
using the voltage measurement to determine a characteristic indicative of a quality of the sintering of the feedstock material.

20. The method of claim 19, wherein:
the circulating a current through the build table comprises using a first pair of electrodes in contact with a surface of the build table; and
the measuring a voltage comprises using a second pair of electrodes in contact with the build table.
